(19) United States
(12) Patent Application Publication
(10) Pub. No.: US 2016/0045929 A1
(43) Pub. Date: Feb. 18, 2016

(54) WINDSHIELD REPAIR APPARATUS INCLUDING SINGLE USE INJECTORS

(71) Applicants: Allan A. SKIDMORE, Burnaby (CA); Keith BEVERIDGE, Edina, MN (US); David OSLAND, Minneapolis, MN (US); Jonathan THOMAS, Maple Lake, MN (US)

(72) Inventors: Allan A. Skidmore, Burnaby, BC (CA); Keith Beveridge, Edina, MN (US); David Osland, Minneapolis, MN (US); Jonathan Thomas, Maple Lake, MN (US)

(21) Appl. No.: 14/776,931

(22) PCT Filed: Mar. 6, 2014
(86) PCT No.: PCT/US2014/021385

§ 371 Date: Sep. 15, 2015

Related U.S. Application Data
(60) Provisional application No. 61/788,305, filed on Mar. 15, 2013.

(51) Int. Cl. B05C 17/005; B05D 7/24; B32B 17/10

(52) U.S. Cl. CPC B05C 17/00576; B32B 17/10963; B05D 7/24; B05C 17/00583; B32B 2255/26; B32B 2605/00

(57) ABSTRACT

An injector including a housing defining an inner passage extending from a first end to a second end; a seal positioned at a first end of the inner passage; internal threads positioned within the internal passage; a plunger threadably engagable with the internal threads of the inner passage; a resin container in communication with the inner passage; and an activation device for activating the resin container.

This application is being filed on 6 Mar. 2014, as a PCT International patent application and claims priority to U.S. Provisional Application Ser. No. 61/788,305, filed Mar. 15, 2013, the subject matter of which is incorporated by reference in its entirety.

### FIELD OF THE INVENTION

The present invention relates to apparatus and methods for repairing breaks in windshields.

### BACKGROUND

From time to time, a vehicle windshield will break, such as due to an object impacting against the windshield. A bull's-eye break may occur wherein the outer layer of safety glass incurs a break in the shape of an inverted cone. Other break shapes and cracks may be incurred in addition to or instead of the bull's-eye break. The inside layer of safety glass is typically unbroken. U.S. Pat. No. 4,291,866, issued Sep. 29, 1981, the disclosure of which is hereby incorporated by reference, illustrates an apparatus usable to repair a break in a vehicle windshield. The apparatus disclosed in the '866 reference includes a support apparatus for supporting an injector held against the windshield so that repair material can be applied to the break site. A repaired windshield is desirable over replacement of the windshield which can be quite costly, and time consuming.

Various concerns arise in connection with repair of windshields. One area of concern relates to the ease of use of the windshield repair apparatus. In particular, the ease in which the site is prepared, and the ease of application of the repair material are concerns. Accessibility to the site for the application of the repair material, and removal of impurities (e.g. air, moisture, dirt) from the break site and from the repair material are concerns. Visual access is also desired. In addition, the application of pressure above atmospheric pressure and the application of pressure below atmospheric pressure at the break site are desirable. Mechanical engagement of portions of the break site is also desirable. A goal of the repair process is to leave an optically invisible or virtually invisible repair site. Minimizing repair material waste is also a concern.

There is a need in the prior art for apparatus and methods which address the above concerns and other concerns.

### SUMMARY

The present invention relates to a windshield repair apparatus including a support apparatus or bridge for holding an injector adjacent to a break area of a windshield. The windshield repair apparatus may include a suction cup for mounting the bridge to the windshield. In some embodiments, the injector is movable, such as for inspection of the repair site or for adjustment of proper positioning of the injector. The injector includes an opening adjacent to a break area on a windshield for the application of repair resin, such as ultraviolet light curable plastic resin. In some embodiments, the injector can be used to apply air pressure above and below atmospheric pressure to the break area. Further, in some embodiments, the injector facilitates use of a tool to mechanically engage the break area to facilitate repair during the application of pressure (plus or minus) and/or the repair material. In the various embodiments disclosed herein, the injector can be a single use injector. In some embodiments, once the repair is completed, the injector is discarded. The resin can be held in a self-contained, single use resin container which is opened at the desired time. The resin container can be held by the injector or mounted to and/or within the injector. The resin container can be discarded with the injector.

### BRIEF DESCRIPTION OF THE DRAWINGS

FIG. 1 is a perspective view of one embodiment of a windshield repair apparatus including an injector;

FIG. 2 is a cross-sectional perspective view of a first embodiment of an injector including aspects of the present disclosure;

FIG. 3 is another cross-sectional perspective view of the injector of FIG. 2;

FIG. 4 is a cross-sectional side view of the injector of FIG. 2;

FIG. 5 is a cross-sectional side view showing the plunger of the injector inserted into position within the outer body to apply resin to a repair site;

FIG. 6 is a plan view of a resin holder before resin is inserted;

FIGS. 7-10 show the resin holder of FIG. 6, with the resin fill port sealed;

FIGS. 11-13 show the resin holder of FIGS. 7-10, with the sealed fill port open and ready for evacuation of the resin;

FIGS. 14 and 15 show an injector with a pipette style resin holder with an externally threaded activation device;

FIG. 15A shows the pipette resin holder of the injector of FIGS. 14 and 15;

FIGS. 16 and 17 show an injector with a pipette style resin holder with an internally threaded actuation device;

FIG. 18 shows an injector with an internal, sealed ampoule of resin, axially locate, with an externally threaded activation device;

FIG. 19 shows an injector with an internal, sealed ampoule of resin axially located, with an internally threaded activation device;

FIGS. 20-22 show an injector with a side resin port and a separate reservoir for resin;

FIG. 23 shows an injector with an internal resin cartridge axially located within the injector outer body;

FIG. 24 shows an injector with a side port and an ampoule of resin within the side port and with an externally threaded activation device;

FIG. 25 shows an injector with a side port and an ampoule of resin within the side port and with an internally threaded activation device.

### DETAILED DESCRIPTION

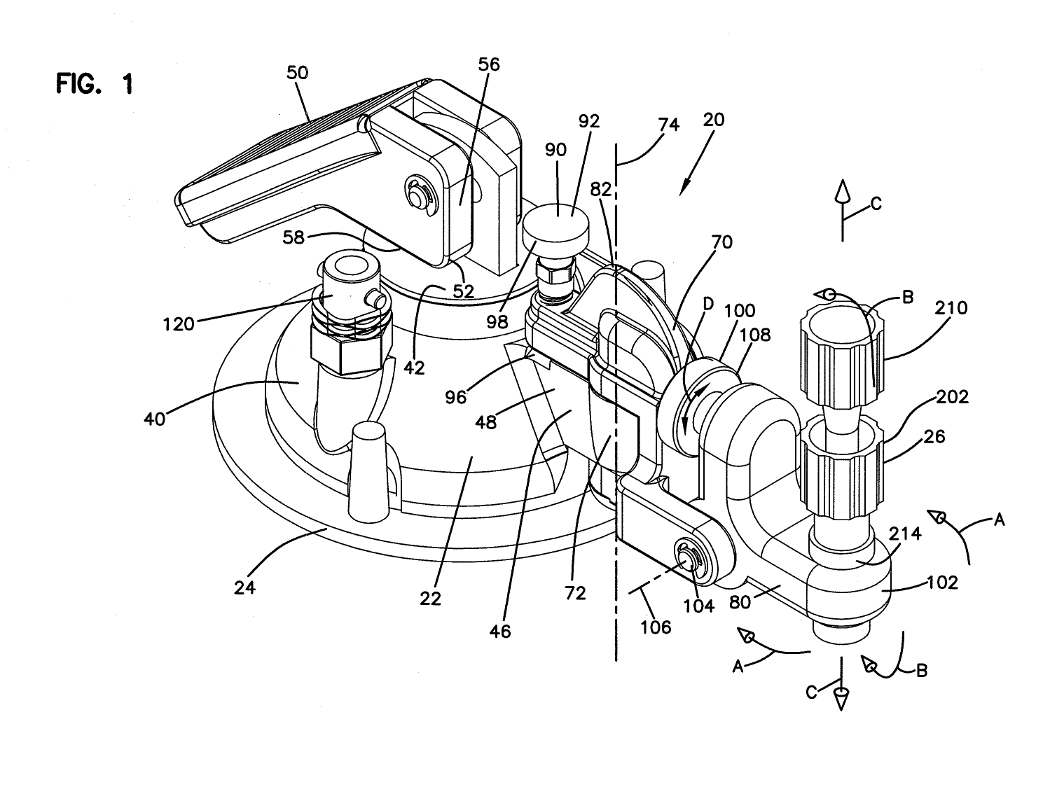

Referring to FIG. 1, a first embodiment of a windshield repair apparatus 20 is shown. Apparatus 20 includes a support apparatus or bridge 22 which mounts to a top surface of a windshield with a resilient suction cup 24. Suction cup 24 supports bridge 22 on the windshield. Bridge 22 holds an injector 26 in opening 28 adjacent to a break area on a windshield for the application of repair resin, such as ultraviolet light curable plastic resin. In addition, injector 26 can be used to apply air pressure above and below atmospheric pressure to the break area. Further, injector 26 facilitates use of a tool to mechanically engage the break area to facilitate repair during the application of pressure (plus or minus) and/or the repair material. Injector 26 can mount to bridge 22 by a threaded engagement, or a bayonet (e.g., quarter twist) arrangement.

Bridge 22 includes a base 40 which mounts to suction cup 24 with a latch 50. Latch 50 lifts a central portion of suction cup 24 upwardly to cause latching of suction cub 24 on the windshield. Latch 50 is an over center latch which includes corners 52 and sides 56, 58 which engage a top 42 of base 40. Top 42 can be an additional wear plate or washer as shown, positioned on a top of the base body. Latch 50 is shown in the latched position in the figures. Latch 50 pivots upward to unlatch the suction cup 24.

Bridge 22 includes an arm 70 which is pivotally mounted about a hinge 72 defining a pivot axis 74 which is generally perpendicular to the windshield. Arm 70 includes a forward portion 80 defining the injection holder, and a rearward portion 82. Rearward portion 82 includes a registration system 90 which allows for securement of arm 70 to a remainder of base 40 at base area 46. Registration system 90 includes a lower pin (not visible) and a slot (not visible) in base area 46. Ramps 96 can lead to the slot so that the pin will automatically fall into the slot once arm 70 is rotated back to the repair position. To rotate arm 70 away from the repair position, to an inspection position, the pin is pulled upwardly out of the slot. Pin 92 is spring loaded. Pin 92 includes a handle 98. Further details of similar registration systems are shown for example in U.S. Pat. No. 6,302,670, the disclosure of which is hereby incorporated by reference. Arm 70 moves in the direction of arrows A in the figures. In the repair position, arm 70 is generally aligned with the side walls 48 of base area 46 to further facilitate ease of use. Further details of the aligned side walls are shown for example in U.S. Pat. No. 6,139,300, the disclosure of which is hereby incorporated by reference.

Forward portion 80 of arm 70 preferably includes a threaded adjustment mechanism 100 which allows for injector 26 to be moved toward and away from the windshield, such as for use on curved portions on the windshield in the direction of arrows B. Injector 26 is also threadably adjustable, as described above for vertical adjustment in the direction of arrows C. Threaded adjustment mechanism 100 includes a front end portion 102 which is hinged at a hinge 104 about a pivot axis 106 which is generally parallel to the windshield. A threaded adjustment screw 108 moves in the direction of arrow D to move front end portion 102 in the direction of arrows B. Front end portion 102 is spring loaded away from the windshield. Further details of the threaded adjustment mechanism 100 and various mounts for injector 26 are shown for example in U.S. Pat. No. 6,139,300, the disclosure of which is incorporated by reference.

Windshield repair apparatus 20 includes an arm attachment location 120 which permits attachment of an articulating arm (not shown) for holding a light, a light blocker (sun shade), and/or a tool holder.

During use of injector 26, resin 200 is applied to the break area through injector 26. Injector 26 includes an outer housing or outer body 202 defining an inner passage 204 and a seal 206. Seal 206 seals against the windshield. Seal 206 includes internal seals 220, 222. Internal threads 208 allow threaded attachment to an axial moveable plunger 210 which includes external threads 212. By moving plunger 210 toward seal 206, the resin 200 is applied to the break area. External threads 214 on outer housing 202 allow for attachment of injector 26 to bridge 26.

Apparatus 20 is an example for holding an injector 26 over a repair site. Other apparatus 20 can be used as desired.

Various resin holders or containers are provided within the present disclosure for managing the resin prior to and during application to the repair site. In some embodiments, the resin holders or containers are single use containers. The resin containers hold a predetermined amount of resin suitable for repair of a typical break site. The injectors are also single use injectors in some preferred embodiments.

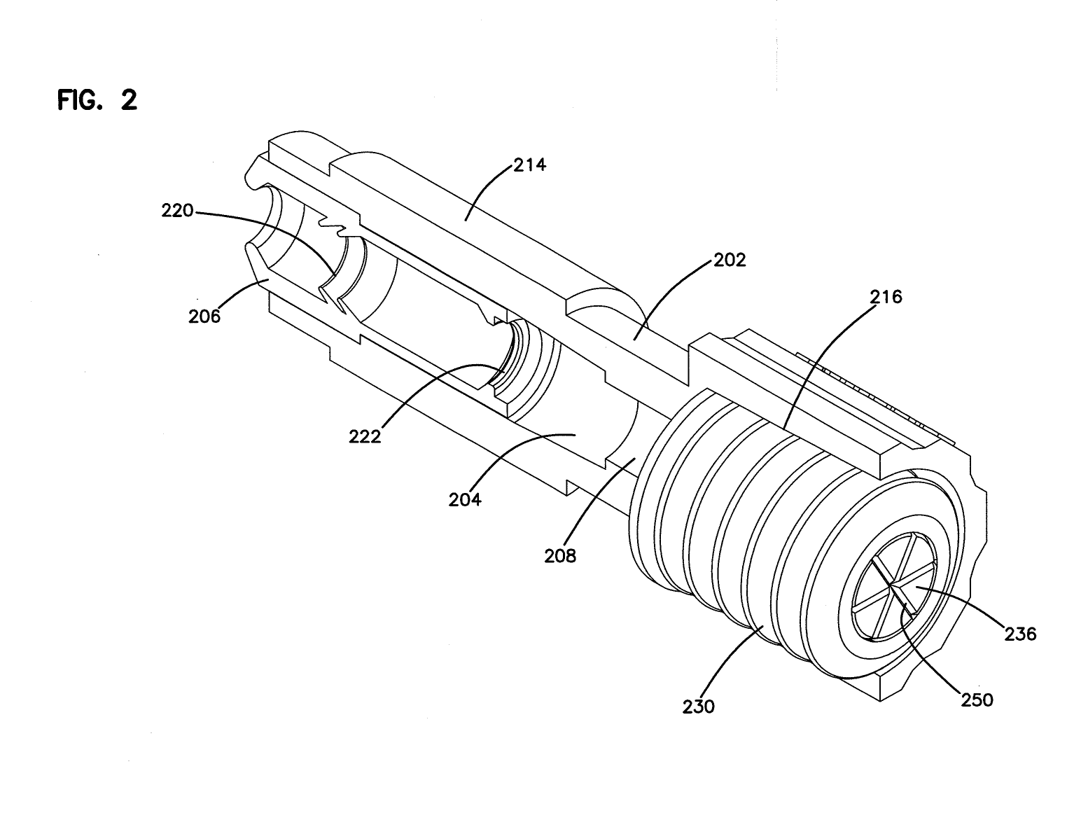

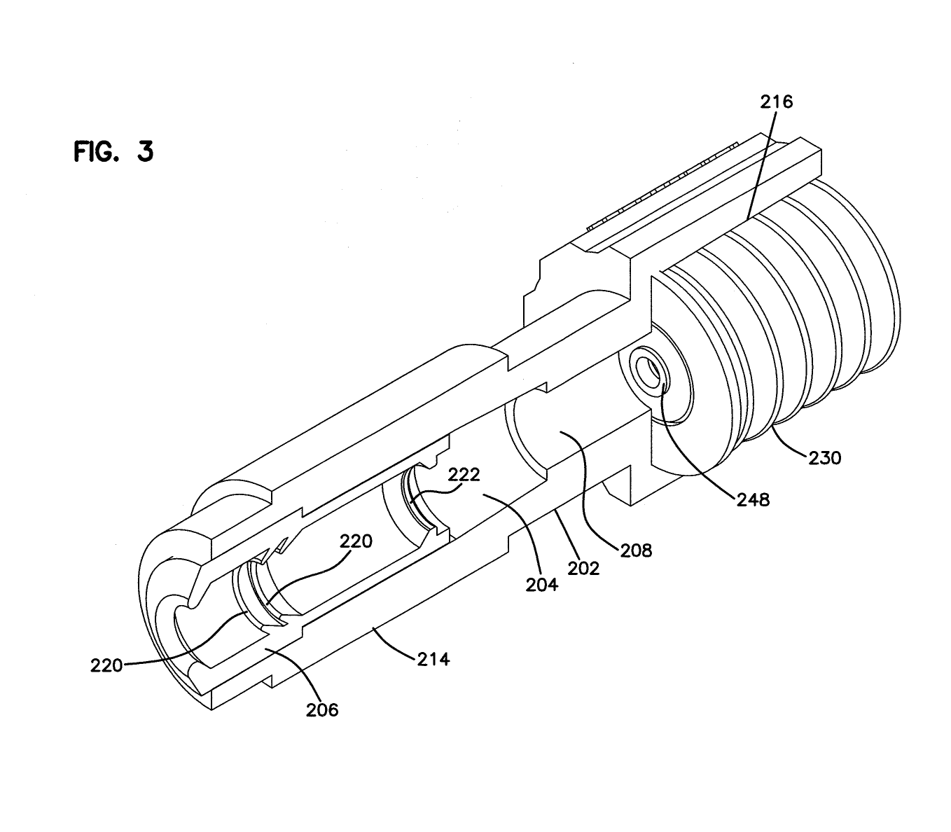

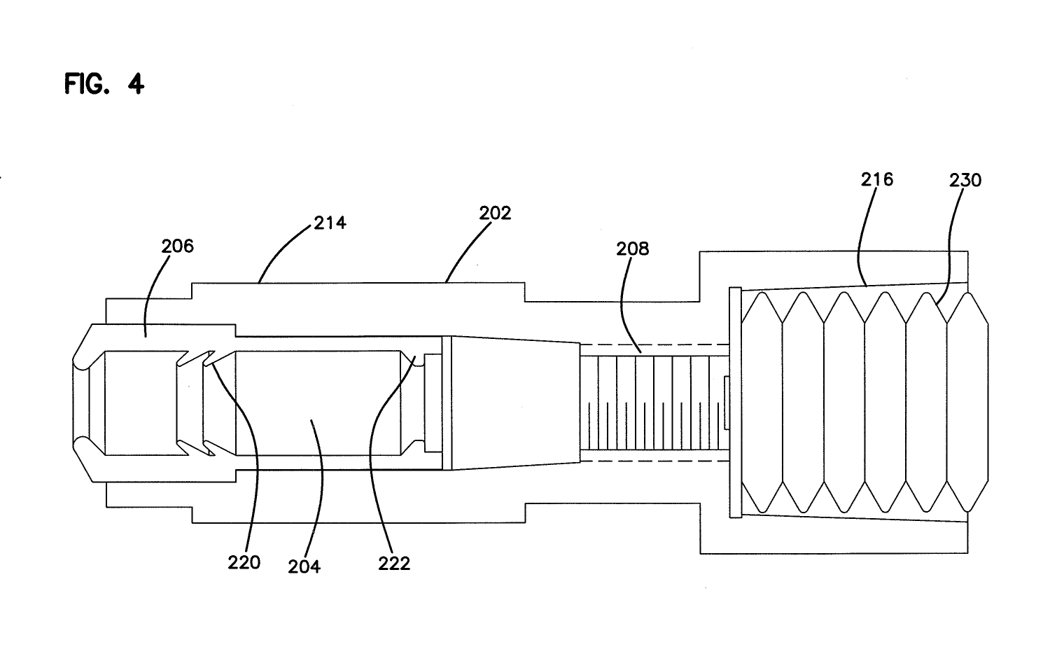

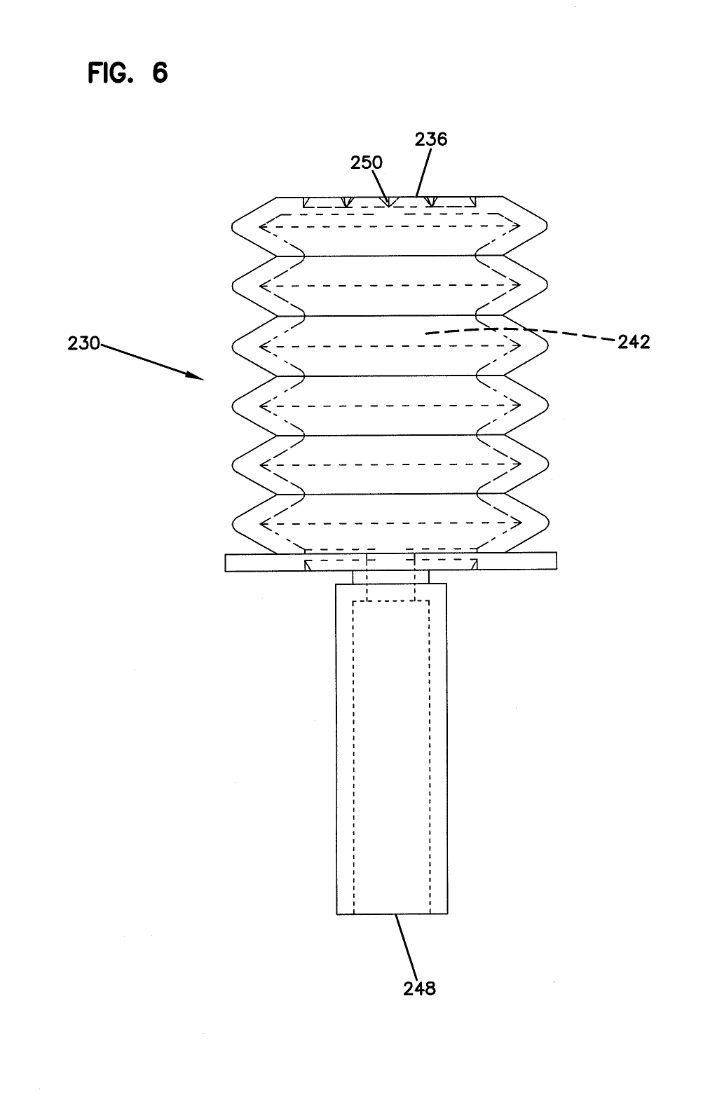

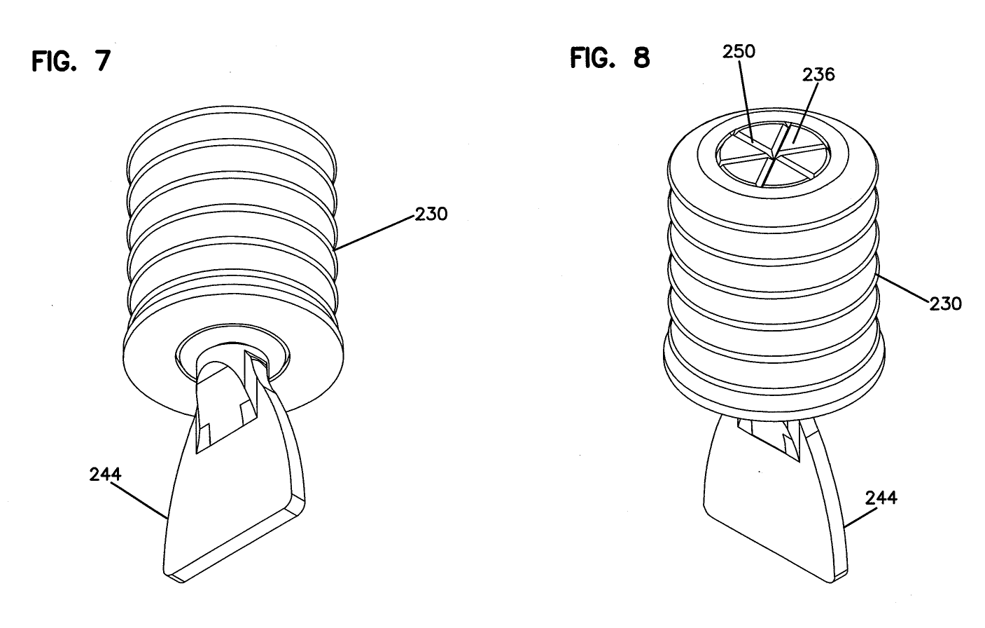

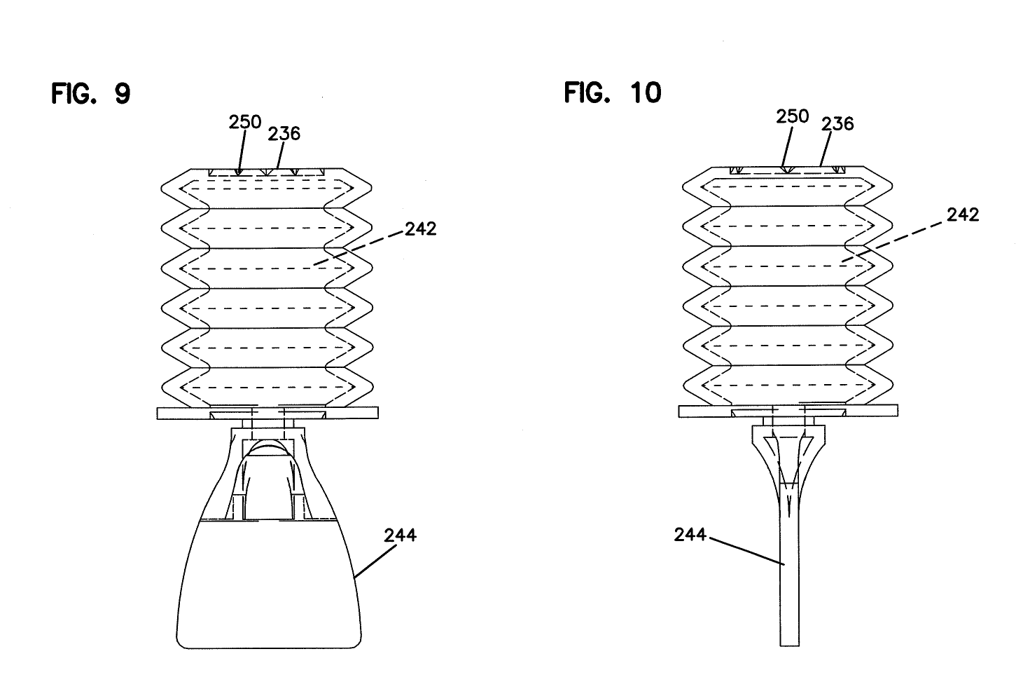

A first example resin holder is shown in FIGS. 2-13 in the form of a bellows 230. Bellows 230 includes a compressible body 232, a first end 234 and an opposite end 236. During manufacture, a fill port 240 connects to an interior 242.

Once resin 200 is placed in interior 242, fill port 240 is sealed as shown in FIGS. 7-10 in the form a flat tab 244. Tab 244 can be broken off at the time the technician desires to inject the resin 200 into the break area.

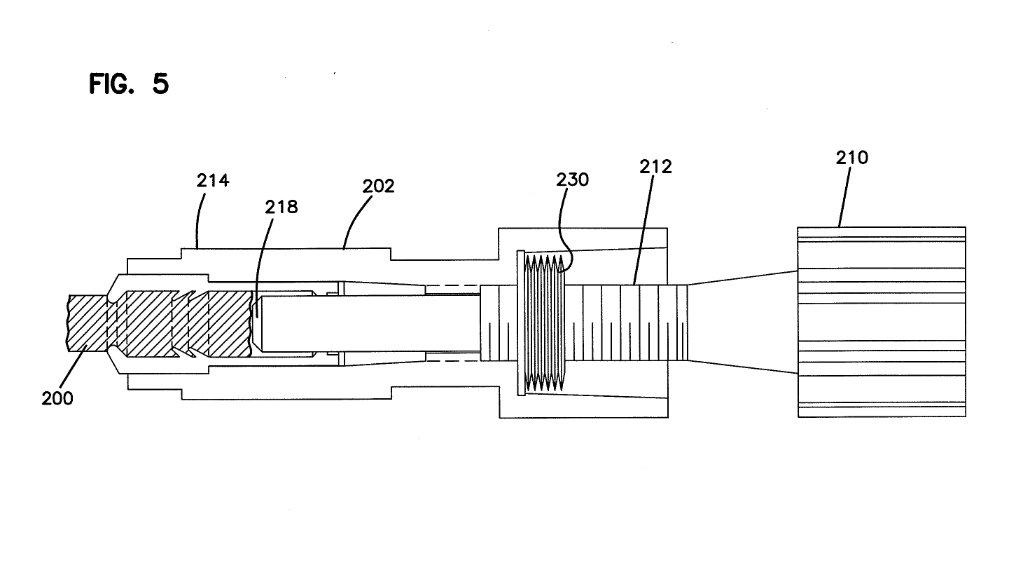

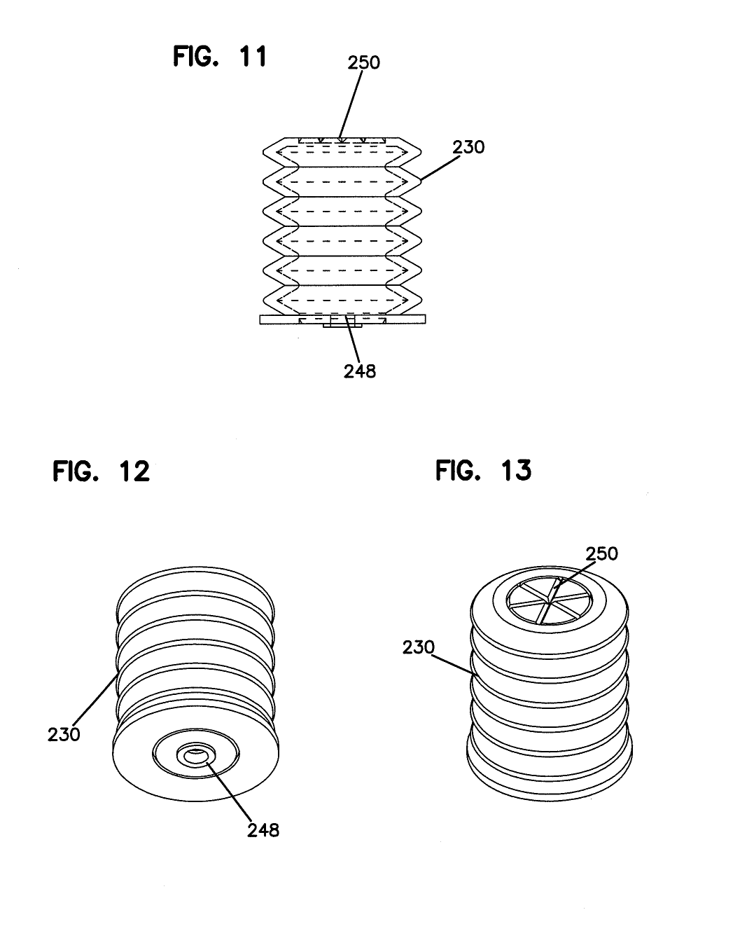

As shown in FIGS. 11-13, bellows 230 is ready for use with an open port 248. At opposite end 236, a weakened area 250 is provided in the form of pie shaped portions with weakened break lines. Bellows 230 is positioned in pocket 216 of outer housing 202 of injector 26 for compression by plunger 210. A tip 218 of plunger 210 pushes bellows 230 to compress bellows 230 and force resin 200 out through open port 248. Eventually, tip 216 of plunger 210 extends through weakened area 250 which opens up, through bellows 230 in the compressed state and through open port 248, pushing the resin 200 towards seal 206 and the break area. See FIG. 5. By manipulating the plunger 210 with the manual application of force, and the additional use of the threads, the bellows empties the contained resin and the plunger 210 pushes the resin toward the break site. Plunger 210 can include a solid construction, or a hollow construction, allowing for the application of pressure and/or manual manipulation of the break site area with a mechanical probe inserted axially. Once the resin has been applied and the repair completed, injector 26 can be discarded, along with bellows 230.

Bellows 230 is one example of a collapsible container for holding resin. Other shapes are possible.

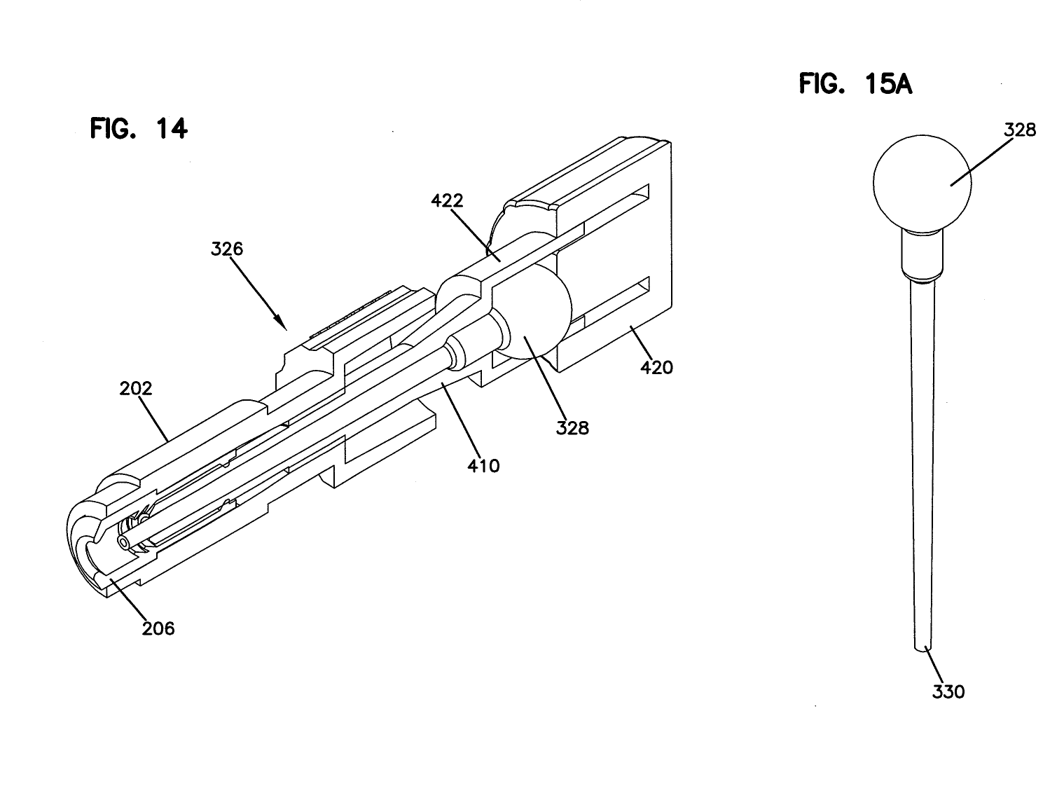

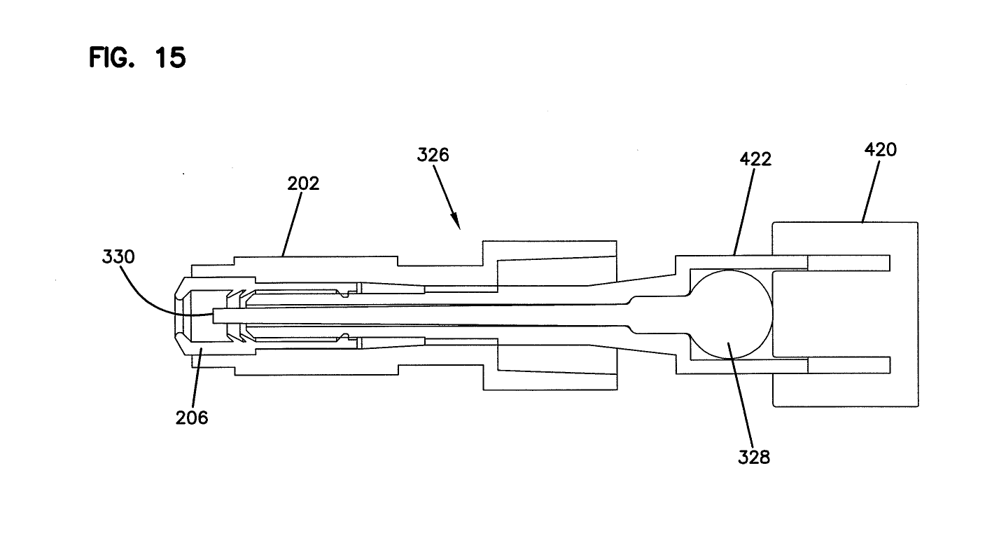

Referring now to FIGS. 14, 15, and 15A injector 326 includes a pipette 328 which holds resin a self-contained area within plunger 410. End cap 420 engages external threads 422 on plunger 410 and empties the contents of pipette 328 into an interior of injector 326 for application to a break site. Plunger 410 can be moved toward the repair site through the threads as noted above. End 330 opens when enough pressure is applied to pipette 328. As shown, plunger 410 is hollow.

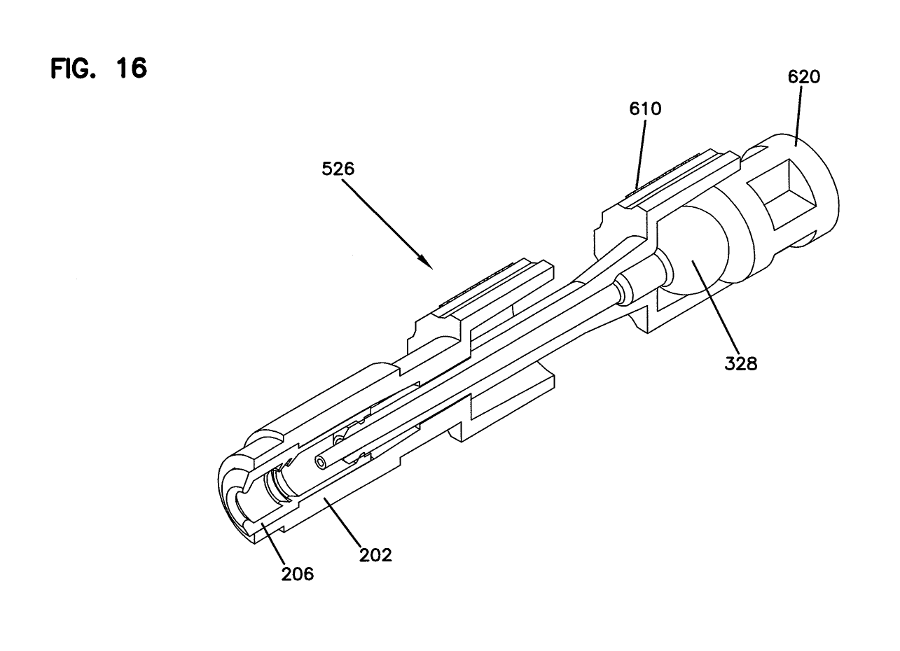

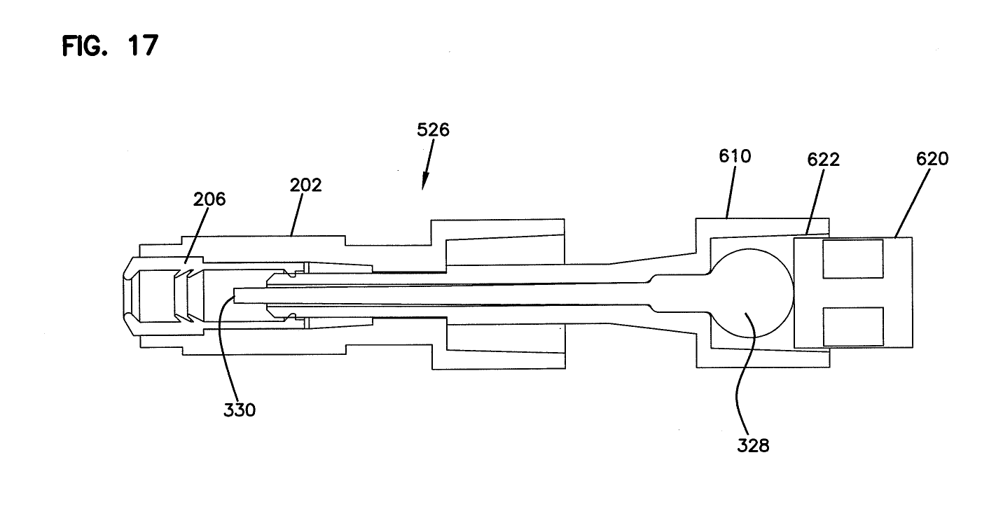

FIGS. 16 and 17 show a similar injector 526 to injector 326 including the use a pipette 328. However, activation is through an end cap 620 which engages internal threads 622 in plunger 610.

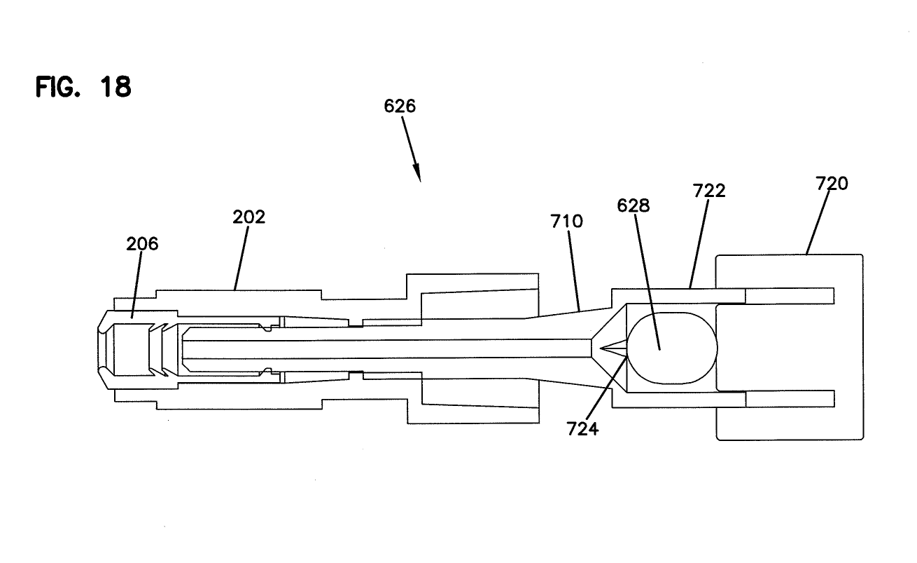

Referring now to FIG. 18, resin is stored in an ampoule 628 in plunger 710 of injector 626. Upon the application of pressure by an end cap 720 engaging external threads 722 on plunger 710, ampoule 628 will open and allow the resin to flow down through plunger 710. A sharp edge 724 on injector 626 may be provided to break open the ampoule 628. As shown, plunger 710 is hollow.

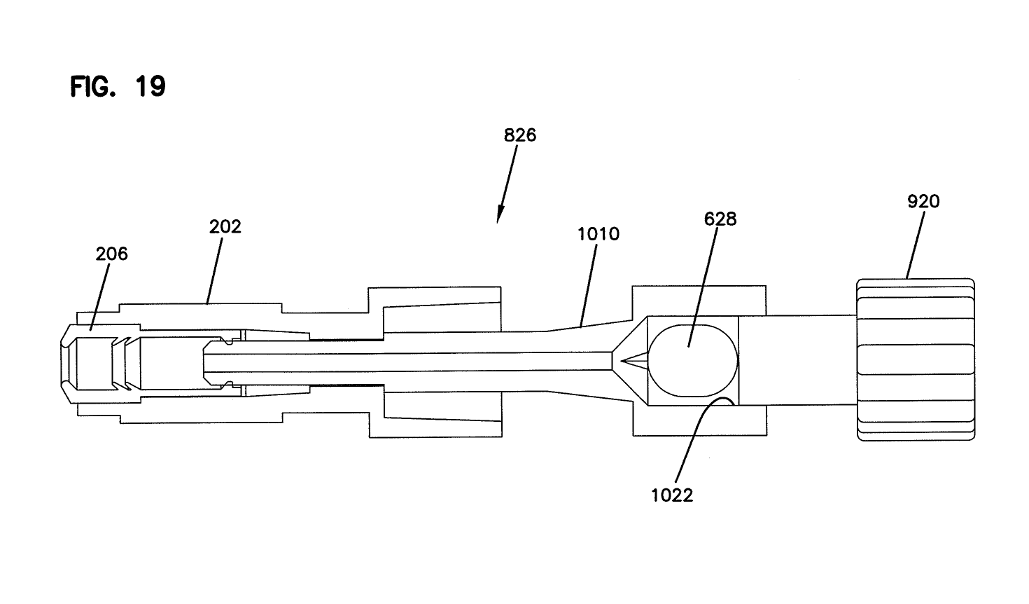

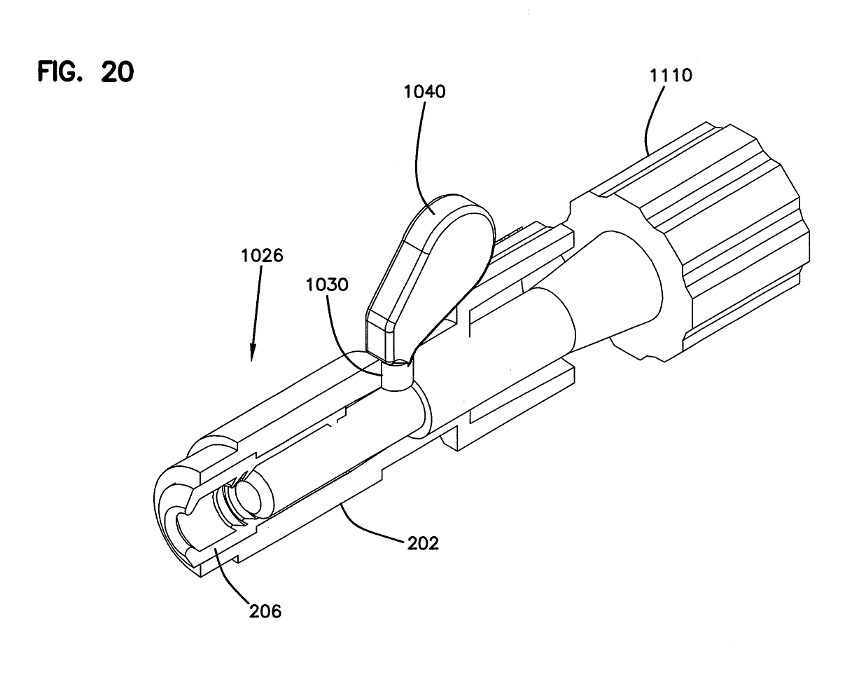

Referring now to FIG. 19, an injector 826 includes an ampoule 628 activated by an end cap 920 which engages internal threads 1022 on plunger 1010.

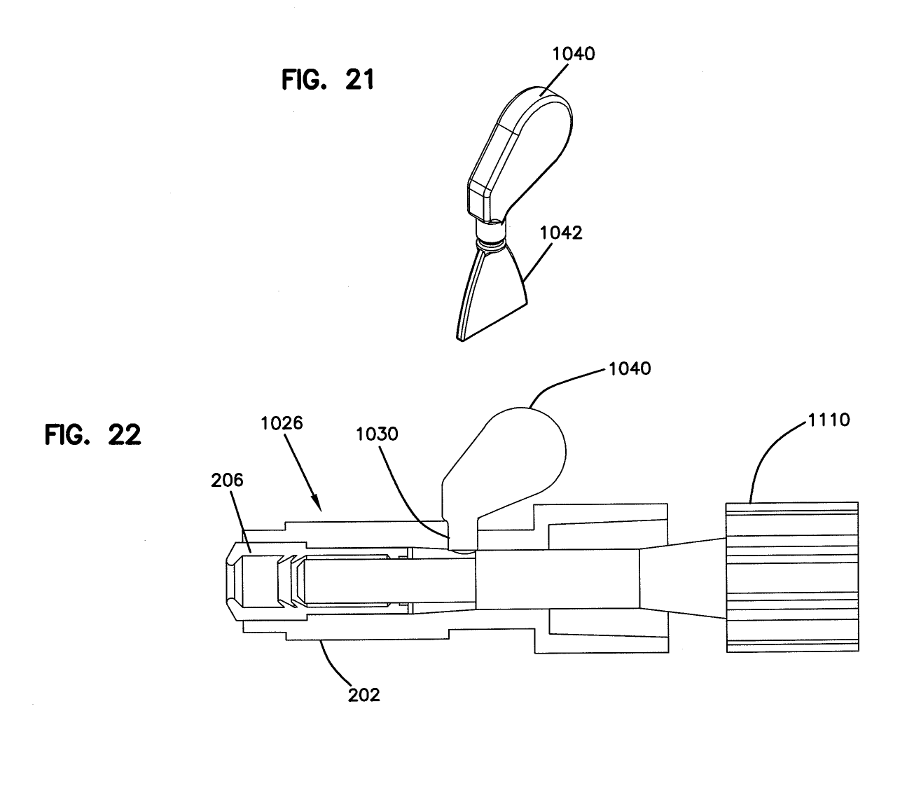

Referring now to FIGS. 20-22, an injector 1026 includes a side port 1030 which is filled with a reservoir 1040. Reservoir 1040 includes a break off tab 1042. Plunger 1110 pushes the resin from reservoir 1040 toward the break site through the use of threads as noted above.

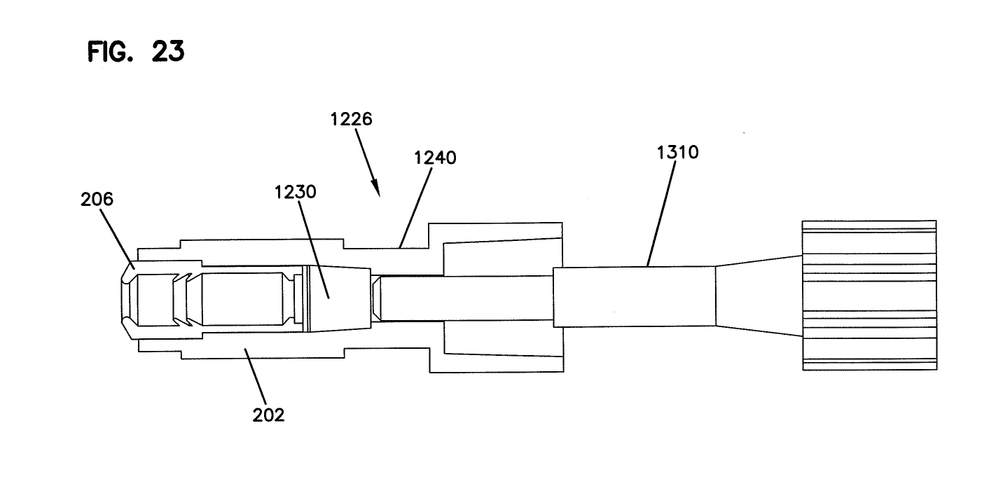

Referring now to FIG. 23, injector 1226 is provided with a central cartridge 1230 of resin positioned below plunger 1310 within housing 1240. Cartridge 1230 may include a weakened area which is broken open by the application of force on plunger 1310 relative to housing 1240, and through the application of force through threaded engagement of plunger 1310 and housing 1240.

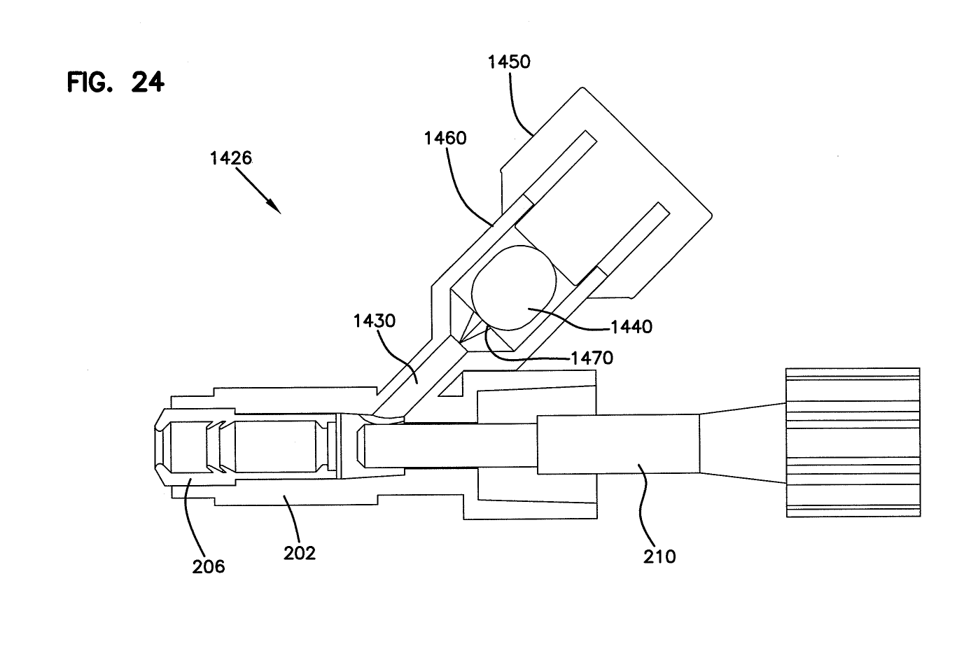

Referring now to FIG. 24, an injector 1426 includes a side port 1430 including an ampoule 1440 of resin which is broken open by the application of force from an end cap 1450 which engages external threads 1460 on the side port 1430, and a sharp edge 1470 disposed within side port 1430.

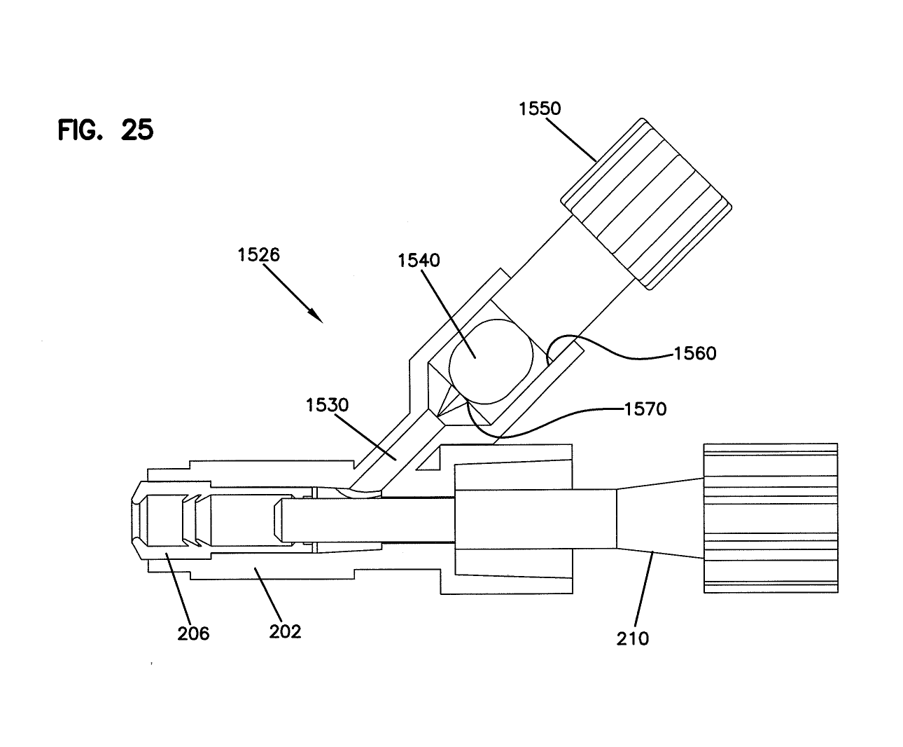

Referring now to FIG. 25, an injector 1526 includes a side port 1530 and an ampoule 1540 which is broken open by the application of force by end cap 1550 which engages internal threads 1560 on the side port 1530, and a sharp edge 1570 disposed within side port 1530.

Use of the single use injectors and resin containers facilitates ease of use for the technician. The technician does not need to fill the injector from a larger container of resin a desired or appropriate amount for the break site. The prefilled resin containers can be prefilled with the correct amount, so the technician need only select an injector or a resin container for an injector and then proceed to make the repair. Waste is reduced and the chance of insufficient resin being provided is also reduced.

The above specification, examples and data provide a complete description of the manufacture and use of the composition of the invention. Since many embodiments of the invention can be made without departing from the spirit and scope of the invention, the invention resides in the claims hereinafter appended.

1. An injector comprising:
a housing defining an inner passage extending from a first end to a second end;
a seal positioned at a first end of the inner passage;
internal threads positioned within the internal passage;
a plunger threadably engagable with the internal threads of the inner passage;
a resin container in communication with the inner passage;
an activation device for activating the resin container to cause expulsion of the contents of the resin container.

2. The injector of claim 1, wherein the activation device includes the plunger.

3. The injector of claim 1, wherein the activation device includes a threaded cap mounted to the plunger.

4. The injector of claim 1, wherein the activation device includes a side port including a threaded activation member.

5. The injector of claim 1, wherein the resin container includes a collapsible bellows.

6. The injector of claim 1, wherein the resin container includes a breakable ampoule.

7. The injector of claim 1, wherein the resin container includes a breakable pipette extending through the plunger.

8. The injector of claim 1, wherein the resin container includes a breakable container positioned at a tip of the plunger.

9. An injector comprising:
a housing defining an inner passage extending from a first end to a second end, and a side port;
a seal positioned at a first end of the inner passage;
internal threads positioned within the internal passage;
a plunger threadably engagable with the internal threads of the inner passage;
a resin container in communication with the inner passage through the side port.

10. A method of using an injector of claim 1, comprising:
opening the resin container;
applying the resin of the resin container to a repair site;
removing the injector from a repair bridge;
mounting a new injector with a new resin container to the repair bridge for repairing another repair site.
